(19) United States
(12) Patent Application Publication
(10) Pub. No.: US 2019/0295783 A1
(43) Pub. Date: Sep. 26, 2019

(54) ELECTROLYTE LIQUID FOR ELECTROCHEMICAL DEVICE AND ELECTROCHEMICAL DEVICE

(71) Applicant: TAIYO YUDEN CO., LTD., Tokyo (JP)

(72) Inventor: Takeo TSUZUKI, Takasaki-shi (JP)

(21) Appl. No.: 16/353,473

(22) Filed: Mar. 14, 2019

(30) Foreign Application Priority Data
Mar. 22, 2018 (JP) 2018-055207

(51) Int. Cl. H01G 11/60; H01G 11/64; H01G 11/06

(52) U.S. Cl. CPC H01G 11/60; H01G 11/06; H01G 11/64

(57) ABSTRACT

Electrolyte liquid for an electrochemical device includes: electrolyte liquid in which solvent of cyclic carbonate includes 0.8 mol/L or more and 1.6 mol/L or less of LiPF₆ as electrolyte; and chain carbonate of which an added amount to the electrolyte liquid is 0.1 wt % or more and less than 10.0 wt %.

### CROSS-REFERENCE TO RELATED APPLICATION

This application is based upon and claims the benefit of priority of the prior Japanese Patent Application No. 2018-055207, filed on Mar. 22, 2018, the entire contents of which are incorporated herein by reference.

### FIELD

A certain aspect of the present invention relates to electrolyte liquid for an electrochemical device, and an electrochemical device.

### BACKGROUND

In electrochemical devices such as electric double layered capacitors or lithium ion capacitors using non-aqueous electrolyte liquid, solvent has a high electrolysis voltage. It is therefore possible to enlarge withstand voltage of the electrochemical devices. And it is possible to store large energy in the electrochemical devices.

Recently, the electrochemical devices are requested to secure reliability under a high temperature condition. With respect to the high temperature reliability, it is thought that characteristic of cells may be degraded because degradation product such as hydrogen fluoride caused by decomposition of anion such as PF₆⁻ acting as the electrolyte may be generated, or a high resistance coating film may be formed because of reduction decomposition of the electrolyte liquid near the negative electrode.

For example, Japanese Patent Application Publication No. 2001-236990 (hereinafter referred to as Document 1) discloses a lithium ion battery including electrolyte liquid in which lithium tetrafluoroborate (LiBF₄) and lithium bis (pentafluoroethylsulfonyl) imide (LiBETI) are mixed by a constant factor. Japanese Patent Application Publication No. 2003-346898 (hereinafter referred to as Document 2) discloses a lithium ion battery including electrolyte liquid in which LiBF₄ is added to lithium hexafluorophosphate (LiPF₆) in order to improve high temperature storage. International Publication No. 2012/017999 (hereinafter referred to as Document 3) discloses electrolyte liquid for improving cycle characteristic of lithium ion batteries or characteristic after a high temperature-keeping test of short period, by adding methylenebis sulfonate dielectric to electrolyte liquid using mixed solvent of carbonic acid ethylene and carbonic acid ethylmethyl.

### SUMMARY OF THE INVENTION

The present invention has a purpose of providing electrolyte liquid for an electrochemical device, and an electrochemical device that are capable of improving high temperature reliability.

According to an aspect of the present invention, there is provided electrolyte liquid for an electrochemical device including: electrolyte liquid in which solvent of cyclic carbonate includes 0.8 mol/L or more and 1.6 mol/L or less of LiPF₆ as electrolyte; and chain carbonate of which an added amount to the electrolyte liquid is 0.1 wt % or more and less than 10.0 wt %.

According to another aspect of the present invention, there is provided an electrochemical device including: a power storage element in which a separator is sandwiched between a positive electrode and a negative electrode, wherein the above-mentioned electrolyte liquid is impregnated in at least one of an active material of the positive electrode, an active material of the negative electrode and the separator.

### BRIEF DESCRIPTION OF THE DRAWINGS

FIG. 1 illustrates an exploded view of a lithium ion capacitor;

FIG. 2 illustrates a cross sectional view of a positive electrode, a negative electrode and a separator, in a stacking direction;

FIG. 3 illustrates an exploded view of a lithium ion capacitor; and

FIG. 4 illustrates an external view of a lithium ion capacitor.

### DETAILED DESCRIPTION

When the electrolyte liquid in which LiBF₄ and LiBFTI are mixed by the constant factor is used as in the case of Document 1, stability of the electrolyte liquid at a high temperature is improved more than electrolyte liquid including LiPF₆ as another electrolyte because the electrolyte of the electrolyte liquid has high heat-resisting characteristic and LiBFTI has high electric conductivity. However, in this case, LiBFTI erodes a collector foil (aluminum) when a positive electrode potential is around 4 V (vs Li/Li⁺). Therefore, the electrolyte liquid has a problem in long-term reliability.

In Document 2, electrolyte liquid in which LiBF₄ is partially added to LiPF₆ is used and battery degradation after high temperature storage is suppressed. At a high temperature (60 degrees C.), LiPF₆ is not thermally decomposed so much. However, at a higher temperature (85 degrees C.), the thermal decomposition of LiPF₆ is not negligible. Therefore, the reliability of the battery may not be necessarily improved.

In Document 3, when the battery is held in a high temperature condition for a long time, problems may occur because a coating film may be further formed on a surface of the negative electrode and the electrolyte liquid may be decomposed.

A description will be given of an embodiment with reference to the accompanying drawings.

### Embodiment

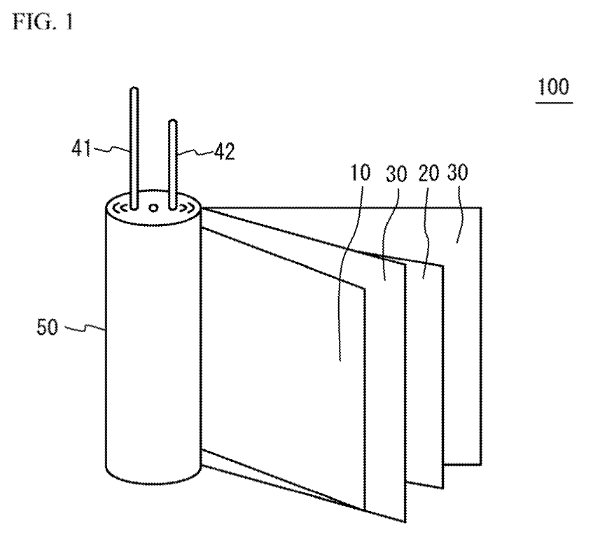

A description will be given of a lithium ion capacitor, as an example of an electrochemical device. FIG. 1 illustrates an exploded view of a lithium ion capacitor 100. As illustrated in FIG. 1, the lithium ion capacitor 100 has a power storage element 50 in which a separator 30 is sandwiched by a positive electrode 10 and a negative electrode 20, and the positive electrode 10, the negative electrode 20 and the separator 30 are rolled together with each other. The power storage element 50 has a columnar shape. A lead terminal 41 is coupled to the positive electrode 10. A lead terminal 42 is coupled to the negative electrode 20.

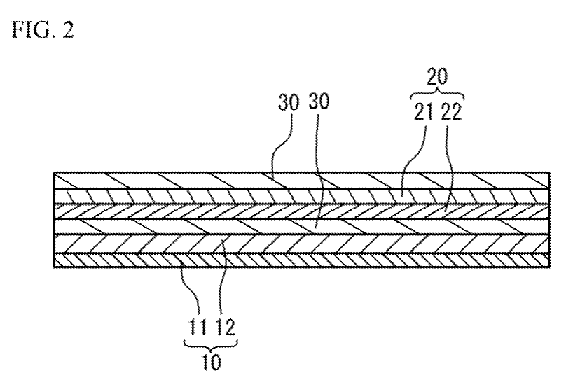

FIG. 2 illustrates a cross sectional view of the positive electrode 10, the negative electrode 20 and the separator 30, in a stacking direction. As illustrated in FIG. 2, the positive electrode 10 has a structure in which a positive electrode layer 12 is stacked on a face of a positive electrode collector 11. The separator 30 is stacked on the positive electrode layer 12 of the positive electrode 10. The negative electrode 20 is stacked on the separator 30. The negative electrode 20 has a structure in which a negative electrode layer 22 is stacked on a face of a negative electrode collector 21, the face being on the side of the positive electrode 10. The separator 30 is stacked on the negative electrode collector 21 of the negative electrode 20. In the power storage element 50, a stack unit composed of the positive electrode 10, the separator 30 and the negative electrode 20 is rolled. The positive electrode layer 12 may be provided on both faces of the positive electrode collector 11. The negative electrode layer 22 may be provided on both faces of the negative electrode collector 21.

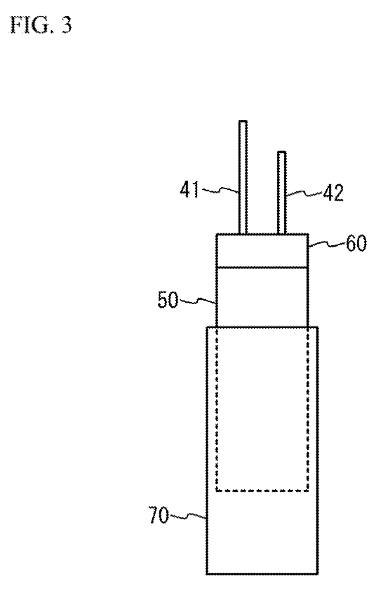

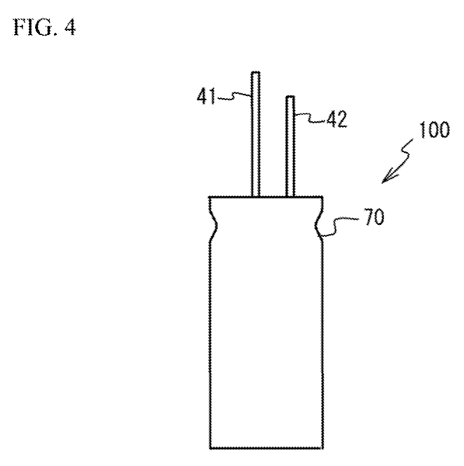

As illustrated in FIG. 3, the lead terminal 41 and the lead terminal 42 are respectively inserted in two through holes of a sealing rubber 60. A diameter of the sealing rubber 60 is substantially the same as that of the power storage element 50. And the sealing rubber 60 has a columnar shape. The power storage element 50 is housed in a container 70 that has a columnar shape having a bottom. As illustrated in FIG. 4, the sealing rubber 60 is caulked around an opening of the container 70. Thus, the power storage element 50 is sealed. Non-aqueous electrolyte liquid is sealed in the container 70. The non-aqueous liquid is impregnated in the active material of the positive electrode 10, the active material of the negative electrode 20, or the separator 30.

(Positive electrode) The positive electrode collector 11 is a metal foil such as an aluminum foil. The aluminum foil may be a perforated foil. The positive electrode layer 12 has a known material and a known structure which are used for an electrode layer of an electric double layered capacitor or a redox capacitor. For example, the positive electrode layer 12 includes an active material such as polyacene (PAS), polyaniline (PAN), activated carbon, carbon black, graphite or carbon nano tube. The positive electrode layer 12 may include another component such as a conductive assistant or a binder which is used for the electrode layer of the electric double layered capacitor.

(Negative Electrode) The negative electrode collector 21 is a metal foil such as a copper foil. The copper foil may be a perforated foil. The negative electrode layer 22 includes an active material such as hardly graphitizable carbon, graphite, tin oxide, silicon oxide. The negative electrode layer 22 may include a conductive assistant such as carbon black or metal powder. The negative electrode layer 22 may include a binder such as polytetrafluoroethylene (PTFE), polyvinylidene fluoride (PVDF), or styrene butadiene rubber (SBR).

(Separator) The separator 30 is provided between the positive electrode 10 and the negative electrode 20. Thus, the separator 30 suppresses short caused by contacting of the both electrodes. The separator 30 holds non-aqueous electrolyte liquid in holes thereof. Thus, the separator 30 has conductive paths between the electrodes. A material of the separator 30 is such as porous cellulose, porous polypropylene, porous polyethylene, porous fluorine resin.

When the power storage element 50 and the non-aqueous electrolyte liquid are housed and sealed in the container 70, a lithium metal sheet is electrically coupled with the negative electrode 20. Thus, lithium in the lithium metal sheet dissolves in the non-aqueous electrolyte liquid. And, lithium ion is pre-doped in the negative electrode layer 22 of the negative electrode 20. Thus, an electrical potential of the negative electrode 20 is lower than that of the positive electrode 10 by approximately 3V, before charge.

In the embodiment, the lithium ion capacitor 100 has a structure in which a rolled type of the power storage element 50 is sealed in the container 70. However, the structure is not limited. For example, the power storage element 50 may have a stacked structure. In this case, the container 70 may be a rectangular-shaped can.

(Non-aqueous electrolyte liquid) The non-aqueous electrolyte liquid can be made by dissolving electrolyte in non-aqueous solvent and adding additive in the non-aqueous solvent. Cyclic carbonate is used as the non-aqueous solvent. For example, the cyclic carbonate is cyclic carbonic acid ester such as propylene carbonate (PC) or ethylene carbonate (EC). The cyclic carbonic acid ester has a high dielectric constant. Therefore, the cyclic carbonic acid ester sufficiently melts lithium salt. The non-aqueous electrolyte liquid using the cyclic carbonic acid ester as the non-aqueous solvent has a high ionic conductivity. Therefore, when the cyclic carbonate is used as the non-aqueous solvent, initial characteristic of the lithium ion capacitor 100 is preferable. When the cyclic carbonate is used as the non-aqueous solvent, electrochemical characteristic during an operation of the lithium ion capacitor 100 is sufficiently stabilized after a coating film is formed on the negative electrode 20.

LiPF₆ which is lithium salt is used as the electrolyte. Among generic lithium salt, LiPF₆ has a high dissociation constant. Therefore, LiPF₆ achieves preferable initial characteristic (capacity and DCR) of the lithium ion capacitor 100. When a concentration of the electrolyte in the non-aqueous electrolyte liquid (a concentration of electrolyte liquid) is excessively high, viscosity of the electrolyte liquid increases and it takes a long time to supply a necessary amount of ion to an electrode. Therefore, an initial inner resistance may increase. On the other hand, when the concentration of the electrolyte liquid is excessively low, the necessary amount of ion may not be necessarily supplied to the electrode or it takes a long time to supply the necessary amount of ion to the electrode. In this case, the initial capacity may decrease and the initial inner resistance may increase. And so, the concentration of the electrolyte liquid has an upper limit and a lower limit. In the embodiment, the concentration of the electrolyte liquid is 0.8 mol/L or more and 1.6 mol/L or less. It is preferable that the concentration of the electrolyte liquid is 1.0 mol/L or more and 1.4 mol/L or less. In the embodiment, LiBFTI is not used as the electrolyte, and corrosion of the positive electrode 10 is suppressed.

(First additive) Chain carbonate is used as a first additive added to the non-aqueous electrolyte liquid, in order to enlarge a capacity maintenance rate and suppressing changing of an inner resistance in a case where the lithium ion capacitor 100 is subjected to a high temperature. It is thought that this is because when a small amount of the chain carbonate is added to the electrolyte liquid, the viscosity of the electrolyte liquid decreases, thereby a material for forming the coating film evenly influences on the negative electrode 20 and a thin, homogeneous and strong coating film is formed. The chain carbonate is such as dimethyl carbonate (DMC), ethyl methyl carbonate (EMC), diethyl carbonate (DEC) or the like. A combination of them may be used as the first additive. When the concentration of the first additive in the non-aqueous electrolyte liquid is excessively low, it is difficult to achieve sufficient effect of the first additive. And so, the concentration of the first additive in the non-aqueous electrolyte liquid has a lower limit. On the other hand, when the concentration of the first additive in the non-aqueous electrolyte liquid is excessively high, the dissociation of LiPF₆ in the electrolyte liquid may be suppressed and thermal decomposition of LiPF₆ may be promoted at a high temperature. And so, the concentration of the first additive in the non-aqueous electrolyte liquid has an upper limit. In the embodiment, the concentration of the first additive in the non-aqueous electrolyte liquid is 0.1 wt % or more and less than 10.0 wt %. It is preferable that the concentration of the first additive in the non-aqueous electrolyte liquid is 9.0 wt % or less. It is more preferable that the concentration of the first additive in the non-aqueous electrolyte liquid is 5.0 wt % or less. It is preferable that the concentration of the first additive in the non-aqueous electrolyte liquid is 0.5 wt % or more. It is more preferable that the concentration of the first additive in the non-aqueous electrolyte liquid is 1.0 wt % or more.

(Second additive) In order to suppress the changing of the inner resistance in a case where the lithium ion capacitor 100 is subjected to a high temperature, at least one of carbonic acid ester, sulfonic acid ester, and oxalate complex salt of lithium may be added to the non-aqueous electrolyte liquid, as a second additive, in addition to the first additive. A reduction potential of the second additive is higher than that of the non-aqueous solvent of the non-aqueous electrolyte liquid. And, the second additive has influence on the negative electrode 20 and forms a stable coating film. Vinylene carbonate (VC), fluoroethylene carbonate (FEC) or the like can be used as the carbonic acid ester. Bis (ethane sulfonate) methylene (MBES) or the like can be used as the sulfonate ester. Bis (oxalate) lithium borate (LiB(C₂O₄)₂), difluoro bis (oxalate) lithium phosphate (LiPF₂(C₂O₄)₂), tetrafluorooxalate lithium phosphate (LiPF₄(C₂O₄)) or the like can be used as the oxalate complex salt of lithium. In order to achieve sufficient effect of the second additive, it is preferable that the concentration of the second additive has a lower limit. On the other hand, when the concentration of the second additive in the non-aqueous electrolyte liquid is excessively high, a thick coating film is formed on the negative electrode 20 and the initial inner resistance may he high. And the changing of the inner resistance may be large. And so, it is preferable that the concentration of the second additive in the non-aqueous electrolyte liquid has an upper limit. In the embodiment, it is preferable that the concentration of the second additive in the non-aqueous electrolyte liquid is 0.1 wt % or more. It is more preferable that the concentration of the second additive in the non-aqueous electrolyte liquid is 0.2 wt % or more. It is still more preferable that the concentration of the second additive in the non-aqueous electrolyte liquid is 0.5 wt % or more. It is preferable that the concentration of the second additive in the non-aqueous electrolyte liquid is 5.0 wt % or less. It is more preferable that the concentration of the second additive in the non-aqueous electrolyte liquid is 3.0 wt % or less. It is still more preferable that the concentration of the second additive in the non-aqueous electrolyte liquid is 1.0 wt % or less.

In the embodiment, the cyclic carbonate is used as the non-aqueous solvent. And, the non-aqueous electrolyte liquid includes 0.8 mol/L or more and 1.6 mol/L or less of LiPF₆ as the electrolyte. Moreover, the non-aqueous electrolyte liquid includes 0.1 wt % or more and less than 10.0 wt % of the chain carbonate. Therefore, even if the lithium ion capacitor 100 is subjected to a high temperature, a preferable capacity maintenance rate is achieved and the changing of the inner resistance is sufficiently reduced. It is therefore possible to improve the high temperature reliability.

In the embodiment, among electrochemical devices, the electrolyte liquid of the lithium ion capacitor is focused on. However, the non-aqueous electrolyte liquid of the embodiment may be used as electrolyte liquid of another electrochemical device such as an electric double layered capacitor.

### EXAMPLES

Lithium ion capacitors were made in accordance with the above-mentioned embodiment. And characteristic was measured.

### Example 1

PAS was used as the active material of the positive electrode 10. Carboxymethyl cellulose and styrene-butadiene rubber were used as a binder, and slurry was prepared. The prepared slurry was coated on a perforated aluminum foil and was shaped into a sheet. Hardly graphitized carbon made of phenolic resin was used as the active material of the negative electrode 20. Carboxymethyl cellulose and styrene-butadiene rubber were used as a binder, and slurry was prepared. The prepared slurry was coated on a perforated copper foil and was shaped into a sheet. The cellulose-based separator 30 was sandwiched between the electrodes. The lead terminal 41 was connected to the positive electrode collector 11 by an ultrasonic welding. The lead terminal 42 was connected to the negative electrode collector 21 by the ultrasonic welding. After that, the positive electrode 10, the separator 30 and the negative electrode 20 were rolled. And the power storage element 50 was fixed by an adhesive tape made of polyimide. The sealing rubber 60 was coupled with the power storage element 50, and the power storage element 50 and the sealing rubber 60 were dried in vacuum atmosphere of 180 degrees C. After that, a lithium foil was attached to the negative electrode 20, and the power storage element 50 was housed in the container 70. Solution (1.10 mol/L) was prepared by dissolving LiPF₆ in PC (100 vol %). After that, as the first additive, 3.0 wt % of EMC was added to the solution. As the second additive, 0.1 wt % of VC was added to the solution. Resulting non-aqueous electrolyte liquid was injected in the container 70. A portion of the sealing rubber 60 was caulked. And, the lithium ion capacitor 100 was made.

### Example 2

In an example 2, an added amount of VC was 0.5 wt %. Other conditions were the same as those of the example 1.

### Example 3

In an example 3, an added amount of VC was 1.0 wt %. Other conditions were the same as those of the example 1.

### Example 4

In an example 4, an added amount of EMC was 0.1 wt %. Other conditions were the same as those of the example 3.

### Example 5

In an example 5, an added amount of EMC was 1.0 wt %. Other conditions were the same as those of the example 3.

### Example 6

In an example 6, an added amount of EMC was 5.0 wt %. Other conditions were the same as those of the example 3.

### Example 7

In an example 7, an added amount of EMC was 9.0 wt %. Other conditions were the same as those of the example 3.

### Example 8

In an example 8, 3.0 wt % of DMC was added instead of EMC. Other conditions were the same as those of the example 3.

### Example 9

In an example 9, 3.0 wt % of DEC was added instead of EMC. Other conditions were the same as those of the example 3.

### Example 10

In an example 10, PC (80 vol %) and EC (20 vol %) were used as the non-aqueous solvent. Other conditions were the same as those of the example 3.

### Example 11

In an example 11, 1.0 wt % of FEC was added instead of VC. Other conditions were the same as those of the example 3.

### Example 12

In an example 12, 3.0 wt % of FEC was added instead of VC. Other conditions were the same as those of the example 3.

### Example 13

In an example 13, 5.0 wt % of FEC was added instead of VC. Other conditions were the same as those of the example 3.

### Example 14

In an example 14, 1.0 wt % of MBES was added instead of VC. Other conditions were the same as those of the example 3.

### Example 15

In an example 15, 1.0 wt % of LiB(C₂O₄) was added instead of VC. Other conditions were the same as those of the example 3.

### Example 16

In an example 16, 1.0 wt % of LiPF₂(C₂O₄) was added instead of VC. Other conditions were the same as those of the example 3.

### Example 17

In an example 17, 1.0 wt % of LiPF₄(C₂O₄) was added instead of VC. Other conditions were the same as those of the example 3.

### Example 18

In an example 18, 3.0 wt % of DMC was added instead of EMC. The second additive was not added. Other conditions were the same as those of the example 1.

### Example 19

In an example 19, the second additive was not added. Other conditions were the same as those of the example 1.

### Example 20

In an example 20, 3.0 wt % of DEC was added instead of EMC. The second additive was not added. Other conditions were the same as those of the example 1.

### Comparative Example 1

In a comparative example 1, neither the first additive nor the second additive was added. Other conditions were the same as those of the example 1.

### Comparative Example 2

In a comparative example 2, the first additive was not added. Other conditions were the same as those of the example 3.

### Comparative Example 3

In a comparative example 3, the first additive was not added. Other conditions were the same as those of the example 11.

### Comparative Example 4

In a comparative example 4, the first additive was not added. Other conditions were the same as those of the example 14.

### Comparative Example 5

In a comparative example 5, the added amount of EMC was 18.0 wt %. Other conditions were the same as those of the example 3.

(Evaluation method) Lithium ion capacitors of the examples 1 to 20 and the comparative examples 1 to 5 were made. After that, the electrostatic capacity and the inner resistance at a room temperature were measured, as the initial characteristic. After that, a float test was performed. In the float test, the lithium ion capacitors were continuously charged for 1000 hours at 3.8 V in a thermostatic tank of 85 degrees C. After the float test, the lithium ion capacitors were cooled as it was, to the room temperature. After that, the electrostatic capacity and the inner resistance were measured again. And changing rates between before the float test and after the float test were calculated. Table 1 and Table 2 show the results (the capacity maintenance rates and the changing rates of the inner resistance).

TABLE 1

| | | 1ST ADDITIVE | | 2ND ADDITIVE | | |
|---|---|---|---|---|---|---|
| | | | ADDED | | ADDED | ELECTROLYTE |
| | SOLVENT | | AMOUNT | | AMOUNT | LIQUID |
| | [vol %] | TYPE | [wt %] | TYPE | [wt %] | [mol/L] |
| EXAMPLE 1 | PC[100] | EMC | 3.0 | VC | 0.1 | 1.1 |
| EXAMPLE 2 | PC[100] | EMC | 3.0 | VC | 0.5 | 1.1 |
| EXAMPLE 3 | PC[100] | EMC | 3.0 | VC | 1.0 | 1.1 |
| EXAMPLE 4 | PC[100] | EMC | 0.1 | VC | 1.0 | 1.1 |
| EXAMPLE 5 | PC[100] | EMC | 1.0 | VC | 1.0 | 1.1 |
| EXAMPLE 6 | PC[100] | EMC | 5.0 | VC | 1.0 | 1.1 |
| EXAMPLE 7 | PC[100] | EMC | 9.0 | VC | 1.0 | 1.1 |
| EXAMPLE 8 | PC[100] | DMC | 3.0 | VC | 1.0 | 1.1 |
| EXAMPLE 9 | PC[100] | DEC | 3.0 | VC | 1.0 | 1.1 |
| EXAMPLE 10 | PC[80]/ | EMC | 3.0 | VC | 1.0 | 1.1 |
| | EC[20] | | | | | |
| EXAMPLE 11 | PC[100] | EMC | 3.0 | FEC | 1.0 | 1.1 |
| EXAMPLE 12 | PC[100] | EMC | 3.0 | FEC | 3.0 | 1.1 |
| EXAMPLE 13 | PC[100] | EMC | 3.0 | FEC | 5.0 | 1.1 |
| EXAMPLE 14 | PC[100] | EMC | 3.0 | MBES | 1.0 | 1.1 |
| EXAMPLE 15 | PC[100] | EMC | 3.0 | LiB(C₂O₄)₂ | 1.0 | 1.1 |
| EXAMPLE 16 | PC[100] | EMC | 3.0 | LiPF₂(C₂O₄)₂ | 1.0 | 1.1 |
| EXAMPLE 17 | PC[100] | EMC | 3.0 | LiPF₄(C₂O₄) | 1.0 | 1.1 |
| EXAMPLE 18 | PC[100] | DMC | 3.0 | — | — | 1.1 |
| EXAMPLE 19 | PC[100] | EMC | 3.0 | — | — | 1.1 |
| EXAMPLE 20 | PC[100] | DEC | 3.0 | — | — | 1.1 |
| COMPARATIVE | PC[100] | — | — | — | — | 1.1 |
| EXAMPLE 1 | | | | | | |
| COMPARATIVE | PC[100] | — | — | VC | 1.0 | 1.1 |
| EXAMPLE 2 | | | | | | |
| COMPARATIVE | PC[100] | — | — | FEC | 1.0 | 1.1 |
| EXAMPLE 3 | | | | | | |
| COMPARATIVE | PC[100] | — | — | MBES | 1.0 | 1.1 |
| EXAMPLE 4 | | | | | | |
| COMPARATIVE | PC[100] | EMC | 18.0 | VC | 1.0 | 1.1 |
| EXAMPLE 5 | | | | | | |

TABLE 2

| | | | AFTER FLOAT TEST | |
|---|---|---|---|---|
| | INITIAL | | | CHANGING |
| | CHARACERISTIC | | CAPACITY | RATE OF |
| | ELECTRO- | INNER | MAINTE- | INNER |
| | STATIC | RESIS- | NANCE | RESIS- |
| | CAPACITY | TANCE | RATE | TANCE |
| | [F] | [mΩ] | [%] | [%] |
| EXAMPLE 1 | 40 | 94 | 81 | 198 |
| EXAMPLE 2 | 40 | 95 | 88 | 180 |
| EXAMPLE 3 | 40 | 98 | 91 | 176 |
| EXAMPLE 4 | 40 | 101 | 86 | 188 |
| EXAMPLE 5 | 40 | 100 | 87 | 180 |
| EXAMPLE 6 | 39 | 98 | 84 | 182 |
| EXAMPLE 7 | 39 | 95 | 80 | 199 |
| EXAMPLE 8 | 40 | 94 | 90 | 178 |
| EXAMPLE 9 | 40 | 96 | 92 | 172 |
| EXAMPLE 10 | 40 | 94 | 90 | 175 |
| EXAMPLE 11 | 40 | 94 | 90 | 176 |
| EXAMPLE 12 | 39 | 98 | 87 | 184 |
| EXAMPLE 13 | 39 | 100 | 82 | 198 |
| EXAMPLE 14 | 39 | 103 | 90 | 186 |
| EXAMPLE 15 | 40 | 100 | 91 | 118 |
| EXAMPLE 16 | 40 | 96 | 91 | 128 |
| EXAMPLE 17 | 40 | 97 | 92 | 136 |
| EXAMPLE 18 | 40 | 93 | 82 | 199 |
| EXAMPLE 19 | 40 | 93 | 82 | 198 |
| EXAMPLE 20 | 40 | 94 | 83 | 196 |
| COMPAR- | 40 | 95 | 64 | 960 |
| ATIVE | | | | |
| EXAMPLE 1 | | | | |
| COMPAR- | 40 | 101 | 78 | 347 |
| ATIVE | | | | |
| EXAMPLE 2 | | | | |
| COMPAR- | 40 | 100 | 77 | 304 |
| ATIVE | | | | |
| EXAMPLE 3 | | | | |
| COMPAR- | 40 | 102 | 81 | 253 |
| ATIVE | | | | |
| EXAMPLE 4 | | | | |
| COMPAR- | 38 | 89 | 56 | 562 |
| ATIVE | | | | |
| EXAMPLE 5 | | | | |

(Initial characteristic) In the examples 1 to 20 and the comparative examples 1 to 5, the electrostatic capacity and the inner resistance of the initial characteristic were preferable values. It is thought that this was because the cyclic carbonate was used as the non-aqueous solvent, and the concentration of LiPF₆ was 0.8 mol/L or more and 1.6 mol/L or less. From the results of the examples 4 to 7, it was confirmed that when the added amount of the first additive became larger, the initial inner resistance became lower.

(High temperature reliability) In the comparative example 1, the capacity maintenance rate was small, and the changing rate of the inner resistance was large. It is thought that this was because neither the first additive nor the second additive was added to the non-aqueous electrolyte liquid, from the comparison between the example 1 and the comparative example 1. Next, in the comparative example 2, although the reduction of the capacity maintenance rate and increasing of the changing rate of the inner resistance were suppressed more than the comparative example 1, the changing rate of the inner resistance was 200% or more and the changing rate of the inner resistance was not sufficiently small. It is thought that this was because the first additive was not added to the non-aqueous electrolyte liquid, from the comparison between the example 3 and the comparative example 2. Next, in the comparative example 3, although the reduction of the capacity maintenance rate and increasing of the changing rate of the inner resistance were suppressed more than the comparative example 1, the changing rate of the inner resistance was 200% or more and the changing rate of the inner resistance was not sufficiently small. It is thought that this was because the first additive was not added to the non-aqueous electrolyte liquid, from the comparison between the example 11 and the comparative example 3. Next, in the comparative example 4, although the reduction of the capacity maintenance rate and increasing of the changing rate of the inner resistance were suppressed more than the comparative example 1, the changing rate of the inner resistance was 200% or more and the changing rate of the inner resistance was not sufficiently small. It is thought that this was because the first additive was not added to the non-aqueous electrolyte liquid, from the comparison between the example 14 and the comparative example 4. Next, in the comparative example 5, the capacity maintenance rate was small. It is thought that this was because the added amount of the first additive was excessively large, from the comparison between the example 3 and the comparative example 5.

On the other hand, in the examples 1 to 20, the reduction of the capacity maintenance rate was suppressed and the changing rate of the inner resistance was sufficiently small (less than 200%). It is thought that this was because the cyclic carbonate was used as the non-aqueous solvent, the non-aqueous electrolyte liquid included 0.8 mol/L or more and 1.6 mol/L or less of LiPF₆ as the electrolyte, and the non-aqueous electrolyte liquid included 0.1 wt % or more and less than 10.0 wt % of the chain carbonate.

From the comparison between the examples 18 to 20 and the examples 1 to 17, the changing rate of the inner resistances of the examples 1 to 17 were smaller than those of the examples 18 to 20. It is thought that this was because the second additive was added in the examples 1 to 17. From the comparison between the examples 1 to 17 and the examples 18 to 20, the types of the first additive and the second additive had little influence.

From the comparison among the examples 1 to 3, it is preferable that the added amount of the second additive was 0.5 wt % or more. On the other hand, from the comparison among the examples 11 to 13, it is preferable that the added amount of the second additive was 3.0 wt % or less.

Although the embodiments of the present invention have been described in detail, it is to be understood that the various change, substitutions, and alterations could be made hereto without departing from the spirit and scope of the invention.

What is claimed is:

1. Electrolyte liquid for an electrochemical device comprising:
electrolyte liquid in which solvent of cyclic carbonate includes 0.8 mol/L or more and 1.6 mol/L or less of LiPF₆ as electrolyte; and
chain carbonate of which an added amount to the electrolyte liquid is 0.1 wt % or more and less than 10.0 wt %.

2. The electrolyte liquid as claimed in claim 1, further comprising at least one of carbonic acid ester, sulfonic acid ester, and oxalate complex salt of lithium, as an additive,
wherein an amount of the additive added to the electrolyte liquid is 0.1 wt % or more and 5.0 wt % or less.

3. The electrolyte liquid as claimed in claim 2, wherein the carbonic acid ester is at least one of vinylene carbonate and fluoro-ethylene carbonate.

4. The electrolyte liquid as claimed in claim 2, wherein the sulfonic acid ester is bis (ethane sulfonate) methylene.

5. The electrolyte liquid as claimed in claim 2, wherein the oxalate complex salt is at least one of bis (oxalate) lithium borate, difluoro bis (oxalate) lithium phosphate and tetrafluorooxalate lithium phosphate.

6. The electrolyte liquid as claimed in claim 1, wherein the chain carbonate is at least one of dimethyl carbonate, ethyl methyl carbonate and diethyl carbonate.

7. An electrochemical device comprising:
a power storage element in which a separator is sandwiched between a positive electrode and a negative electrode,
wherein the electrolyte liquid as claimed in claim 1 is impregnated in at least one of an active material of the positive electrode, an active material of the negative electrode and the separator.
